(19) United States
(12) Patent Application Publication
(10) Pub. No.: US 2017/0169372 A1
(43) Pub. Date: Jun. 15, 2017

(54) AUTOMATED PROJECT CYCLE MANAGEMENT SYSTEM BASED ON SEGMENT COMPLETION

(71) Applicants: David J. Kuethman, Wethersfield, CT (US); Andrew M. Savage, Suffield, CT (US); Aaron Christman, Clay, NY (US)

(72) Inventors: David J. Kuethman, Wethersfield, CT (US); Andrew M. Savage, Suffield, CT (US); Aaron Christman, Clay, NY (US)

(21) Appl. No.: 14/968,188

(22) Filed: Dec. 14, 2015

(51) Int. Cl. G06Q 10/06

(52) U.S. Cl. CPC G06Q 10/06312; G06Q 10/06313

(57) ABSTRACT

Embodiments provide a system for managing segments of a project cycle based upon completed segments, the system comprising: a display device; a database for storing data associated with the project cycle; a processor; a memory, with the memory storing instructions executable by the processor to: access the data stored in the database to obtain information relating to the project cycle, wherein the project cycle comprises a plurality of segments; the plurality of segments having an identified order, wherein the starting time of a segment is dependent on an ending time of a previous segment occurring directly previous to the segment in the identified order; identify at least one uncompleted segment; identify an ending time associated with a most recently completed segment; adjust the starting time of the at least one uncompleted segment based upon the ending time of the most recently completed segment; and display, on the display device, the adjusted starting time of the at least one uncompleted segment.

### BACKGROUND

Companies have projects which may have different phases or segments contained within them. As an example, a project may include ordering a product. The start of the project may be knowing the product needs to be ordered. The end of the project may be the product has been ordered. However, usually there are additional phases or segments to complete for ordering a product. Example phases include creating a purchase order, approving the purchase order, and placing the purchase order. Typically only the entire project time is monitored and if one of the phases fails to be finished on time, the entire project time is considered not met. This presents a problem to a company in identifying if there is a particular phase of the project that is not being consistently completed on time.

One solution to this problem is that if an employee notices that a phase of the project is not being completed on time, the employee can notify management. However, a single employee may not be responsible for every phase of the project and may not notice if another phase is not being completed on time. Therefore, there is a need for a project cycle management tool which allows a company to identify individual segments of the project and whether each individual segment is being completed on time or within a goal time.

### BRIEF SUMMARY

In summary, an embodiment provides a system for managing segments of a project cycle based upon completed segments. In an embodiment, a database stores data associated with a project cycle. The project cycle may include a plurality of segments having an identified order. In one embodiment the project cycle may have a project cycle time which may be indicate how long the project cycle should take to complete. In one embodiment the project cycle time may be indicated in business hours.

The system includes a processor that executes a program of instructions to access the data stored in the database to obtain information relating to the project cycle. An embodiment may identify an order of the segments including a starting time associated with each segment within the project cycle. The starting time of the segment may be dependent on the ending time of a segment occurring directly before the segment of interest in the identified order. In one embodiment each segment may have a goal cycle time which may indicate how long the segment should take to complete. In one embodiment the goal cycle time may be indicated in business hours.

The program of instructions may identify at least one uncompleted segment within the project cycle. Based on the uncompleted segment, an embodiment may identify a most recently completed segment which was previously finished before the uncompleted segment. One embodiment may identify the ending time of the most recently completed segment. Based on the ending time, an embodiment may adjust the starting time of the uncompleted segment. Using a display device of the system, an embodiment may display the adjusted starting time of the uncompleted segment. One embodiment may additionally adjust the project cycle time based upon the adjustment of times associated with uncompleted segments.

In one embodiment the uncompleted segments having an actual cycle time greater than the goal cycle time may be identified. An embodiment may then display a graphical user interface with any uncompleted segments having actual cycle times greater than the goal cycle time. In one embodiment the graphical user interface including the uncompleted segments may be displayed as percentages indicating the percentage of uncompleted segments being over the goal cycle time versus the uncompleted cycle times being under the goal cycle time.

Additional embodiments are described, including other methods, as well as devices/apparatuses, systems including multiple devices, and products. The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example method for managing segments of a project cycle based upon completed segments.

FIG. 2 illustrates an example project cycle including segments.

FIG. 3 illustrates an example graphical user interface illustrating segment completion.

FIG. 4 illustrates an example graphical user interface illustrating open segments.

FIG. 5 illustrates an example graphical user interface illustrating historical segment completion.

FIG. 6 illustrates an example system for managing segments of a project cycle based upon completed segments.

FIG. 7 illustrates an example system for device management able to support multiple distributed networked centers.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An embodiment addresses the issue of project cycle management from a cycle segment perspective rather than an overall project perspective. As will become more apparent in the description of example embodiments, the discussed technological improvements offered by the various embodiments are applicable to companies and individuals who have or maintain project cycles having multiple phases or segments.

Although various example embodiments are described with a focus on insurance claim management, the principles and technological improvements offered may likewise be applied to various other project cycles, for example, service requests, product purchases, approval processes, employee management, and the like, in which a project cycle has multiple segments. Thus, embodiments permit companies or other entities which have or maintain project cycles having segments or phases to leverage knowledge of uncompleted segments or phases in order to identify segments which are consistently failing to meet goal cycle times. Additionally, embodiments permit an entity maintaining the project cycle time to adjust starting times for uncompleted segments to be dependent on completed segments. This allows the uncompleted segments to be timed with emphasis on how long that particular segment takes as opposed to the goal cycle time for the segment being considered unmet because a previous segment was not completed on time. In turn a company is then aware of which segments are actually not being completed within the goal time as opposed to which segments get pushed due to previous segments being behind schedule.

An embodiment utilizes a data driven approach to identify uncompleted segments and segments which are not completed within the goal cycle time of the segment as opposed an identification that the entire project cycle has not been completed within a desired timeframe. An embodiment provides a system and method of managing large amounts of data relating to any and all segments and project cycles that a company may maintain. An embodiment may receive and process data contained within multiple data sources, including local and non-local data sources, into a usable format which may allow a user and/or company to make determinations relating to project cycles and segments within the project cycles. The terms user and company may be used interchangeable throughout to increase readability. Once received and processed, an embodiment may provide output, for example, graphical user interfaces, prompts, databases, and the like, to a display device which may allow a user to access, sort, filter, and the like, the data related to a particular project cycle or segment within the project cycle.

An embodiment may access a database storing data associated with a project cycle. For example, a company may store information relating to a project cycle, for example, goal times, segments, overall time, responsible parties, and the like, in a database. The data may be stored or retrieved from more than one database or data source. For example, a company may store information relating to different phases in different databases or storage locations. The storage locations may be local, remote, or third-party storage locations. The project cycle may include a plurality of segments.

An embodiment may then identify a preferred order for completion of the segments. For example, a company may have a preferred order for completing segments. In addition, an embodiment may identify a starting time associated with each of the segments within the project cycle. The starting time of one segment may be dependent on the ending time of a segment previous to the segment of interest. For example, the segment of interest may be dependent on a previous segment being completed before it can be started. Once an embodiment identifies the desired order, segment dependencies, and starting times for a segment, an embodiment may identify an uncompleted segment within the project cycle. After identifying the uncompleted segment, an embodiment may identify a segment which has been completed before the uncompleted segment. The completed segment may be prior to or after the uncompleted segment in the preferred order and may include the most recently completed segment before the uncompleted segment. After identifying the most recently completed segment an embodiment may determine the ending time of the completed segment and adjust the starting time of the uncompleted segment to be consistent with the ending time of the completed segment.

After adjusting the starting time of the uncompleted segment a user can request display data from an embodiment. In one embodiment the displayed data may include just the adjusted starting time of the uncompleted segment. However, with the information regarding uncompleted segments, an embodiment may additionally identify and display interfaces which indicate how many segments are not being completed within the goal time. This may allow a company to identify a segment which is lagging or is a bottleneck for completing subsequent segments.

Thus, embodiments represent a significant technical improvement to management of project cycles. An embodiment is directed to substantially more than merely a computer implementation of a routine or conventional activity previously known in the industry as it significantly advances the technical efficiency, access, and/or accuracy of managing project cycles having multiple segments or phases and ensures that a company has visibility of segments or phases that are causing bottlenecks within the desired process or project cycle by implementing a specific new method and system as defined herein.

An embodiment provides a specific advancement in the area of project cycle management by providing technical benefits in data accuracy, data availability, and data integrity and such advances are not merely a longstanding commercial practice. The embodiments provide improvement beyond a mere generic computer implementation as they involve the compilation, processing, reconciliation, and conversion of significant amounts of data in a new beneficial manner as well as the interaction of a variety of specialized systems, networks, and subsystems.

For example, an embodiment facilitates the identification and reconciliation of data associated with a particular segment of a project cycle. In order to accomplish this, an embodiment identifies an uncompleted segment within the project cycle. Upon making this ascertainment, an embodiment offers a further technological advancement by reconciling the starting time of an uncompleted segment with the ending time of a completed segment. This allows a company to identify and understand which segments and phases in a project cycle are not completed within the desired cycle time as opposed to just understanding that the project cycle was not completed on time. In other words, using the systems and methods described herein, a company can identify a single segment causing delays and focus on improving the timing of this single segment as opposed to attempting to reconfigure, modify, or adjust the entire project cycle.

An embodiment additionally offers a further technological advancement by processing and manipulating the data into a format to be displayed to a user. An embodiment then allows a user the flexibility to view more information or sort and/or filter the data into different formats or views. Thus, embodiments provide the technology necessary to automate the manipulation of significant amounts of data from a data source to allow a company the ability to identify project segments having timing issues and focus on the improvement of these segments.

The illustrated example embodiments will be best understood by reference to the figures. The following description is intended only by way of example, and simply illustrates certain example embodiments.

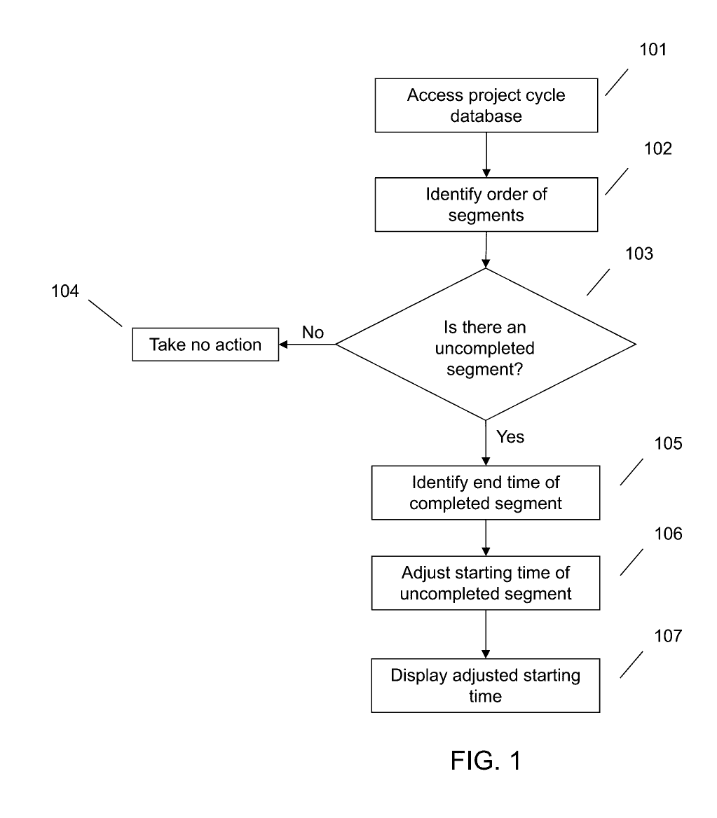

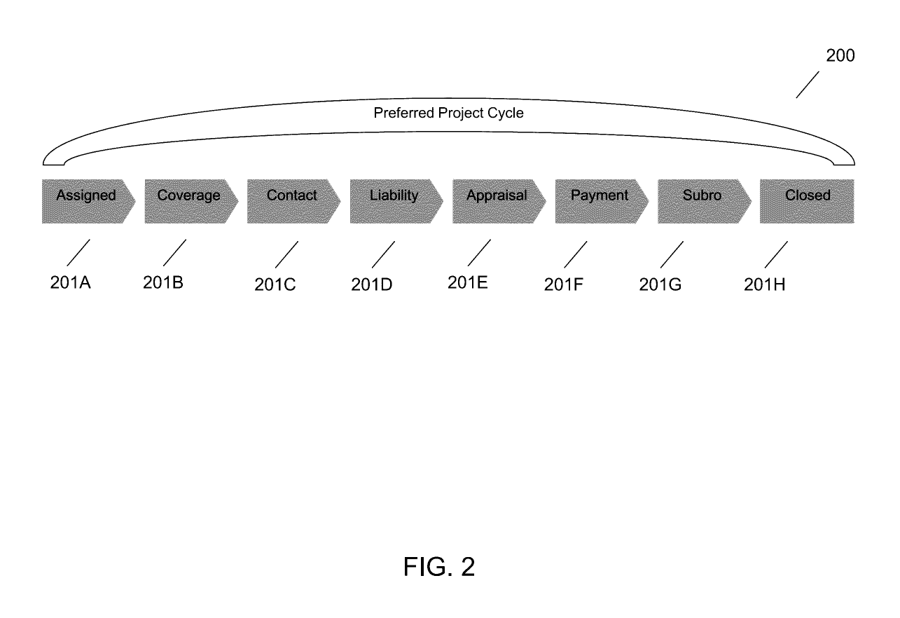

FIG. 1 illustrates an example method of managing segments of a project cycle based upon completed segments. At 101 an embodiment may access data stored within a database to obtain information relating to a project cycle. Information may include segments contained within the project cycle, a preferred order of completion of the segments, a project cycle time designating a length of time for completion of the project cycle, responsible parties, segment goal times, segment dependencies, and the like. The project cycle may have a plurality of segments having an identified order. For example, referring to FIG. 2, an insurance company may have a project cycle 200 relating to claim management. The claim management project cycle may have segments 201A-201H relating to assignment of the claim 201A, identification of claim coverage 201B, contacting the insured party 201C, identification of liability 201D, completion of appraisal 201E, issuance of payment 201F, pursuance of subrogation 201G, closing the claim 201H, and the like. The insurance company may also have a preferred order (e.g., 201A-201H in that order) for completing each of the segments. For example, assignment of the claim 201A should occur before coverage is determined 201B, which should be completed before contacting the insured party 201C, and so on.

In one embodiment, the project cycle may be associated with a project cycle time. The project cycle time may designate how long the project cycle should take to be completed. For example, an insurance company may indicate that from assignment of a claim to closing the claim should take sixty days. In one embodiment, the project cycle time may be calculated based on business hours. For example, if the project cycle should take sixty days from assignment to close, the sixty days would be calculated as business days. In other words, the system may take into account holidays and weekends due to the fact that workers may not work on these days. The system is not just limited to business days, but may identify hours, minutes, and even seconds. For example, using business hours the system may take into account a start time of 8:00 AM and an end time of 5:00 PM. Using such a calculation provides a more accurate view of how long a project or segment within the cycle takes to complete.

At 102 an embodiment may identify an order of the segments within the project cycle. The order may include a preferred order for completion of the segments. For example, a company may desire that a certain segment is completed before another segment is started. In identifying the order of the segments, an embodiment may identify a starting time associated with each segment in the project cycle. The starting time may not be an exact time, for example, 5:30 PM, but rather may be a starting condition. For example, the starting time of one segment may be dependent on the completion of a previous segment. In the insurance example used above, the preferred or identified order may indicate that contacting the insured party 201C should occur after identification of coverage 201B. Therefore, the starting time of contacting the insured party is identified as when the identification of coverage has been completed. In other words, the identified starting time of a segment of interest may be dependent on an ending time of a segment which occurs directly previous to the segment of interest in the identified order.

In one embodiment, a goal cycle time for each of the segments may also be identified. For example, a first segment may have a goal cycle time of 8 hours. As with the project cycle time, an embodiment provides that the goal cycle time for each of the segments may be calculated or identified using business hours. This ensures that a segment's actual cycle time includes time that the worker could work on the claim. As an example, assume the segment of interest has a cycle time of 8 hours and the system does not take into account business hours. If a worker receives the segment at 5:00 PM and has left for home, by the time the worker returns to work at 8:00 AM the next morning, the segment is already indicated as late even though the worker had no time to work on the segment. By taking into account the actual business hours, the 8 hour desired cycle time would not start counting until the worker arrives at work at 8:00 AM the next day. Additionally, such an approach allows goal cycle times to be hours apart, rather than larger units of measure such as days. In other words, a segment may have a goal cycle time of four hours as opposed to requiring the minimum time to be a day.

At 103, an embodiment may identify if there is at least one uncompleted segment contained within the project cycle. The uncompleted segment may include a segment that has not been started. Alternatively, the uncompleted segment may include a segment that has been started but not finished. In one embodiment, the identification of the segment includes the first non-completed segment in the identified order. For example, an embodiment may start with the first segment in the identified order and identify whether it has been completed. If it has been completed, an embodiment may go to the second segment in the identified order and identify whether that segment has been completed, and so on. If an embodiment determines that there are no uncompleted segments at 103, an embodiment may take no further action at 104.

If, however, an embodiment identifies at least one uncompleted segment at 103, an embodiment may identify an ending time associated with a most recently completed segment that was completed before the uncompleted segment at 105. As an example, assume that the uncompleted segment is the liability segment 201D. An embodiment may identify which of the segments (e.g., 201A-201C and 201E) has been completed and which of the completed segments was the most recently completed segment. For example, if 201E was most recently completed, 201E would be the most recently completed segment used. In other words, an embodiment may utilize the completed segment which was most recently completed in relation to the segment of interest (e.g., the uncompleted segment). The ending time of the last completed segment is the time that the segment was actually completed as opposed to the goal cycle time. For example, if the goal cycle time is 20 hours, but the segment actually took 40 hours, the 40 hours would be used rather than the 20 hours.

This method forces the segments into a linear pattern. Additionally, if a worker has completed the segments out of order, for example, assessing liability 201D before contacting the insured party 201C, the calculation of the cycle time is based on actually completed segments as opposed to the uncompleted segments being anchored to the segment directly previous to the uncompleted segment within the identified order. As an example, if the worker has completed assessing liability 201D before contacting the insured party 201C, but has been assigned the claim 201A and identified coverage 201B before assessing liability, the most recently completed segment may be considered the assessing liability segment 201D, rather than the contacting the insured party segment 201C.

At 106, an embodiment may adjust the starting time of the uncompleted segment to be dependent on the ending time of the most recently completed segment. For example, the goal cycle time for an uncompleted segment may be based upon the most recently completed segment. Such a calculation ensures that the goal cycle time for the uncompleted segment that is dependent on the completed segment is not impacted by the fact that the completed segment took longer than was desired or expected. Additionally, the cycle time for the uncompleted segment is not impacted by the segments being completed out of order. In one embodiment, the project cycle time may be adjusted based upon the adjusted segment starting time. For example, if a segment starting time is moved forward by twenty days, the overall project cycle time may be increased by twenty days.

At 107, an embodiment may display, using a display device or peripheral device (e.g., printer, fax machine, etc.) the adjusted starting time of the uncompleted segment. In displaying the adjusted starting time, an embodiment may display a prompt notifying a user of the adjusted starting time. An embodiment may additionally or alternatively display a graph or user interface showing the adjusted starting time. As an example, an embodiment may adjust a project plan chart based upon the new starting time.

After identifying uncompleted segments, cycle times associated with the uncompleted segments, and goal cycle times for the uncompleted segments, an embodiment may identify uncompleted segments having an actual cycle time greater than the goal cycle time. In one embodiment this identification comprises comparing the actual cycle time to the goal cycle time. The actual cycle time may include how long it took for the uncompleted segment to be completed. The actual cycle time may also include the current cycle time for an uncompleted segment. For example, if a segment has not yet been completed, an embodiment may identify how long a segment has taken from the time the segment was started. This information may also be updated dynamically, for example, when a report is run, at a predetermined time (e.g., at the start of a work day, at the end of a work day, at 10:00 AM everyday, etc.), as segments are completed, and the like. Upon making this identification, an embodiment may display the uncompleted segments having an actual cycle time greater than the goal cycle time. An embodiment may also identify a percentage of segments which have been completed within the goal cycle time.

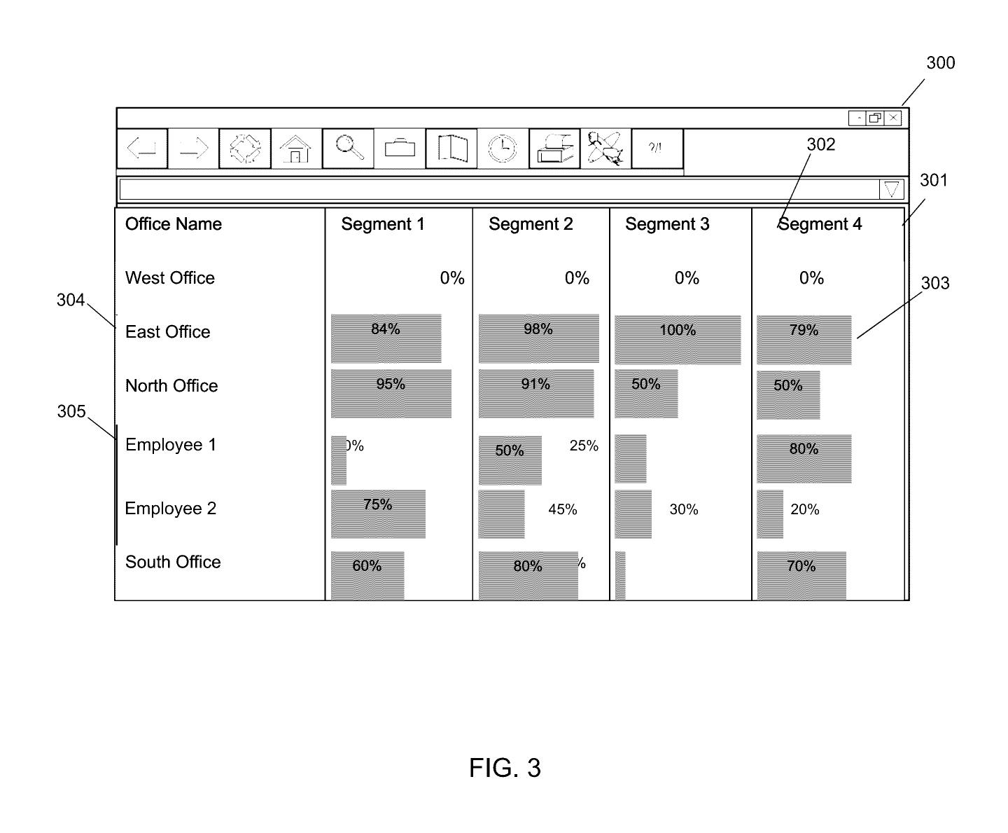

An embodiment may additionally provide different graphical views for use by a user. Referring to FIG. 3, an embodiment may provide a view 301, for example on a display device 300, which indicates the percentage of uncompleted segments which are within the goal cycle time. The view may indicate the designation of the segment 302. The view may display how many projects at the particular segment 302 have been completed, for example, as a percentage 303, number, fraction, and the like. As an example, using FIG. 3, 79% (303) of the projects at Segment 4 (302) in the East Office (304) are within the goal cycle time, implying that 21% are not within the goal cycle time. The information may additionally be associated with a particular employee 305 in an office. In other words, a user can identify an employee having the most uncompleted segments. FIG. 3 is only an example, and the graphical view may be reorganized or include additional information, for example, an average, a total average, a total amount of segments over the goal cycle time, additional segments, and the like.

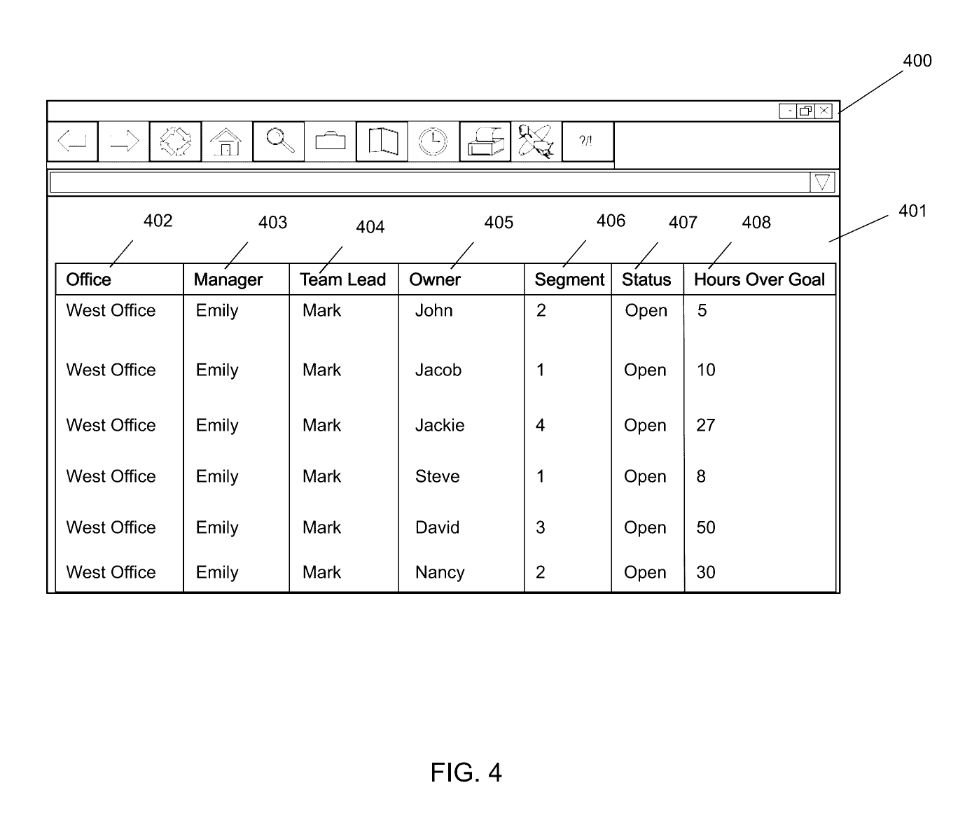

A company may want to identify which segments are currently outside the goal cycle time, for example, to focus on these overdue segments. Therefore, an embodiment may produce a list or report 401, for example on a display device 400, including this information as in FIG. 4. The list may include the associated office 402. The user may also be able to sort or filter data based upon column headings or other information. For example, if a user is attempting to identify all the overdue uncompleted segments in a particular office, the view may be filtered by office name. The list may also include the manager 403 and team lead 404 associated with the owner 405. The owner may be the person responsible for completing the segment 406. For example, in an insurance setting, the owner 405 may be the person responsible for processing the claim. The view may also designate which segment 406 is outside the cycle time and the status 407 of the segment 406. For example, whether the segment 406 is complete (e.g., closed) or incomplete (e.g., open). The view may also designate how many hours over the goal 408 the segment 406 is. This view may also dynamically update, for example, as described above. This view may also include additional information, for example, a unique identifier associated with a project, totals, averages, and the like.

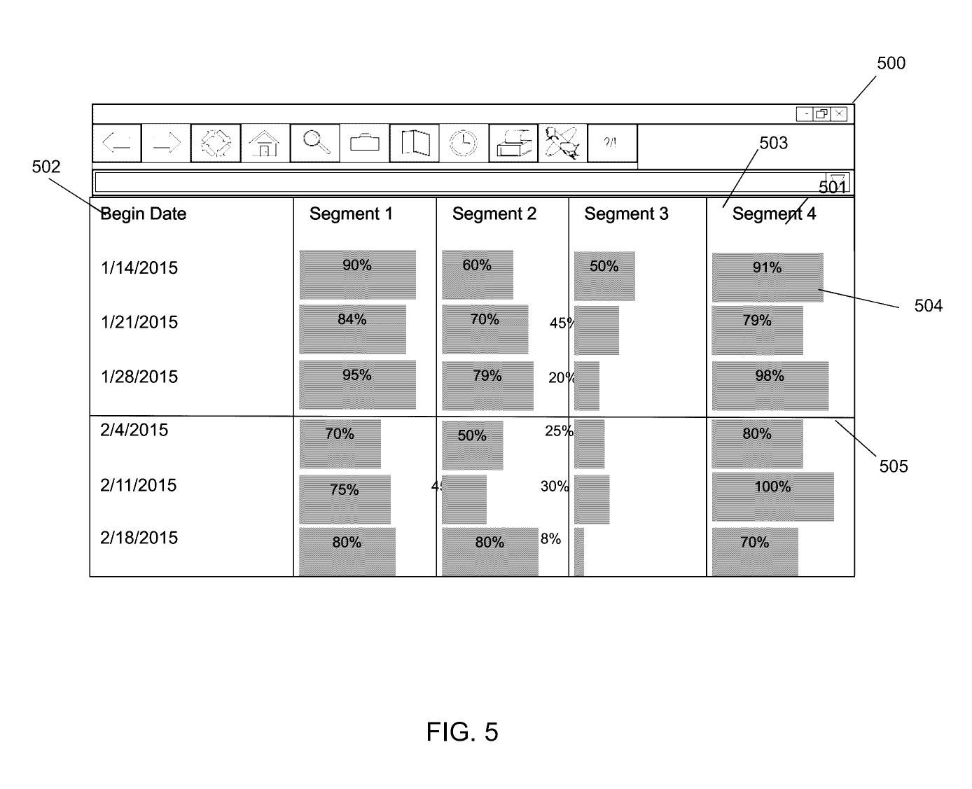

The data identified may be used by an embodiment to create an assessment for a particular employee or individual. For example, an embodiment may display how many segments an employee completes within the goal cycle time. Additionally, an embodiment may be used to create a historical view 501, for example, at FIG. 5 on a display device 500. This view 501 may show a percentage of segments which were complete or incomplete over a particular time period. For example, a begin date 502 may be chosen. Each segment 503 may then be designated and the percentage 504 associated with how many were completed within or by the begin date 502 may be displayed. The percentage 504 may also be shown as a number, fraction, the number that were incomplete, and the like. Additionally, a user may wish to create a visual indication 505 (e.g., a snap line, highlighting, circling, etc.) corresponding to a specific event. For example, if a procedure was changed on Jan. 28, 2015, a user may want to create a snap line 505 to see if the procedure created an impact on completion percentages. More than one visual indication may be possible. As with the other example views (e.g., FIG. 3 and FIG. 4), this view may include additional or alternative information. Other views and forms of manipulating and displaying information relating to segments within the project cycle are contemplated and possible.

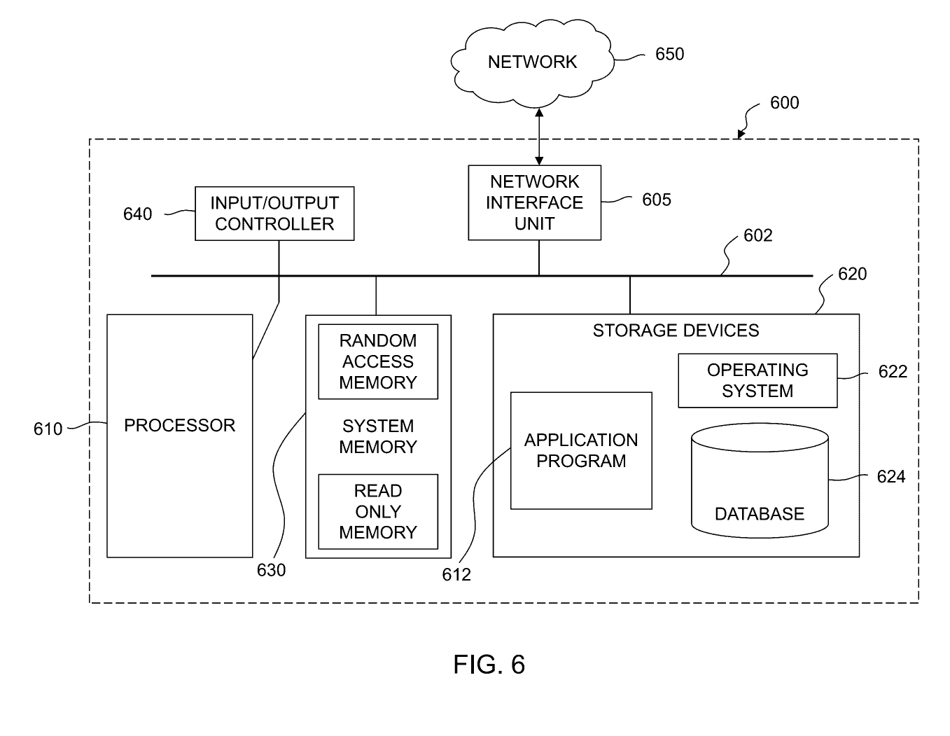

In the example of FIG. 6, a storage device 620 includes software such as a device manager application program 612 that may be run or executed by processor(s) 610 according to an operating system 622. The circuitry 600 provides that the processor loads the operating system 622 and thereafter the application program 610, e.g., into memory 630.

System 600 typically includes a network interface 605 facilitating communications with other devices, e.g., a connection to other devices over a network 650 using components such as a WWAN transceiver, a WLAN transceiver or a wired connection, e.g., a LAN connection. Commonly, system 600 will include an input/output controller 640 for data input and display. System 600 typically includes various memory 630 and storage devices 620, for example a database 624, e.g., for storing data from internal and external data sources, referred to herein.

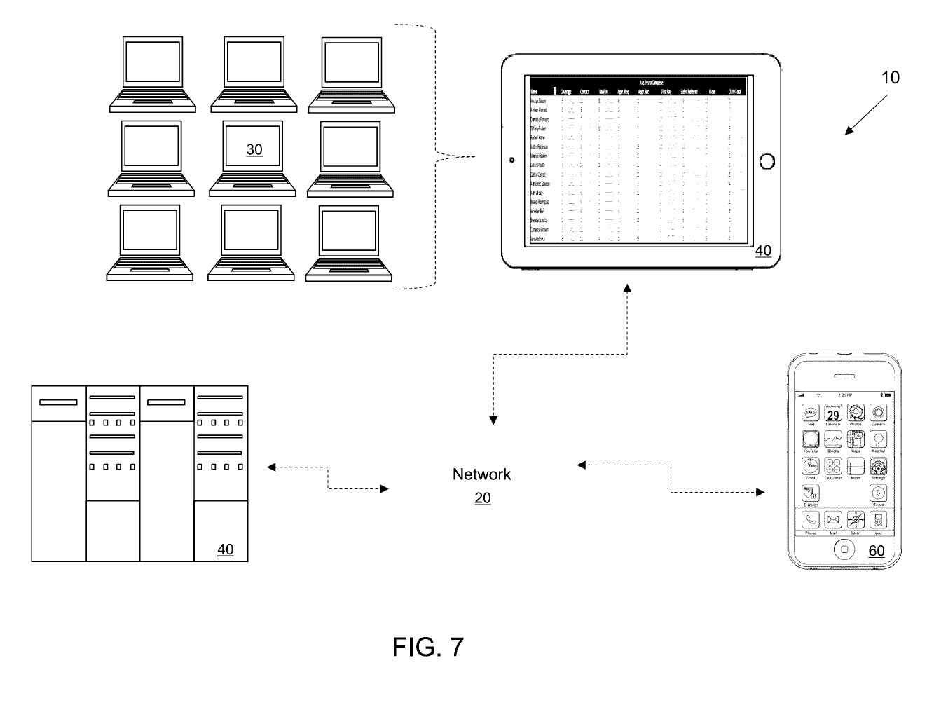

Referring to FIG. 7 there is shown a system 10 for device management that is able to support multiple distributed networked centers in accordance with a preferred embodiment of the present invention. The system 10 is preferably comprised of a communication network 20, a call center 30, a management terminal 40, servers 50, and mobile device 60. Terminal 40 is operable to track and manage call center 30 and provide communications to and from servers 40 and device 60.

Device circuitry, as for example outlined in FIG. 6 and FIG. 7, may be used to manage project cycles and segments within the project cycles as described herein. It will also be apparent that circuitry other than the non-limiting example outlined in FIG. 6 and FIG. 7 may be used.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system for managing segments of a project cycle based upon completed segments, the system comprising:
a display device;
a database for storing data associated with the project cycle;
a processor;
a memory, with the memory storing instructions executable by the processor to:
access the data stored in the database to obtain information relating to the project cycle, wherein the project cycle comprises a plurality of segments and wherein the project cycle is associated with a project cycle time designating a length of time for completion of the project cycle;
the project cycle time being calculated based on business hours;
the plurality of segments having an identified order, wherein a starting time of a segment is dependent on an ending time of a previous segment occurring directly previous to the segment in the identified order;
identify at least one uncompleted segment;
identify an ending time associated with a most recently completed segment;
adjust the starting time of the at least one uncompleted segment based upon the ending time of the most recently completed segment;
adjust the project cycle time based upon the adjustment of the at least one uncompleted segment starting time; and
display, on the display device, the adjusted starting time of the at least one uncompleted segment and the adjusted project cycle time.

2. The system of claim 1, wherein the instructions are further executable by the processor to identify a goal cycle time associated with each segment within the project cycle, wherein the goal cycle time designates a length of time for completion of a segment; and
wherein the goal cycle time is calculated based on business hours.

3. The system of claim 2, wherein the instructions are further executable by the processor to identify uncompleted segments having an actual cycle time greater than the goal cycle time.

4. The system of claim 2, wherein the instructions are further executable by the processor to display, on the display device, the uncompleted segments having an actual cycle time greater than the goal cycle time.

5. The system of claim 2, wherein the instructions are further executable by the processor to identify a percentage of segments completed within the goal cycle time.

6. The system of claim 5, wherein the instructions are further executable by the processor to generate a report identifying the percentage of segments completed within the goal cycle time.

7. The system of claim 1, wherein the plurality of segments comprise: an assigned segment, a coverage segment, a contact segment, a liability segment, an appraisal segment, a payment segment, a subrogation segment, and a closed segment.

8. A system for managing segments of a project cycle based upon completed segments, the system comprising:
a display device;
a database for storing data associated with the project cycle;
a processor;
a memory, with the memory storing instructions executable by the processor to:
access the data stored in the database to obtain information relating to the project cycle, wherein the project cycle comprises a plurality of segments;
the plurality of segments having an identified order, wherein the starting time of a segment is dependent on an ending time of a previous segment occurring directly previous to the segment in the identified order;
identify at least one uncompleted segment;
identify an ending time associated with a most recently completed segment;
adjust the starting time of the at least one uncompleted segment based upon the ending time of the most recently completed segment; and
display, on the display device, the adjusted starting time of the at least one uncompleted segment.

9. The system of claim 8, wherein the project cycle is associated with a project cycle time designating a length of time for completion of the project cycle; and
wherein the instructions are further executable by the processor to adjust the project cycle time based upon the adjustment of the at least one uncompleted segment starting time.

10. The system of claim 9, wherein the project cycle time is calculated based on business hours.

11. The system of claim 8, wherein the instructions are further executable by the processor to identify a goal cycle time associated with each segment within the lifecycle, wherein the goal cycle time designates a length of time for completion of a segment.

12. The system of claim 11, wherein the instructions are further executable by the processor to identify uncompleted segments having an actual cycle time greater than the goal cycle time.

13. The system of claim 11, wherein the instructions are further executable by the processor to display, on the display device, the uncompleted segments having an actual cycle time greater than the goal cycle time.

14. The system of claim 11, wherein the instructions are further executable by the processor to:
identify a percentage of segments completed within the goal cycle time; and
generate a report identifying the percentage of segments completed within the goal cycle time.

15. A system having a graphical user interface for managing segments of a project cycle based upon completed segments, the system comprising:
a database for storing data associated with the project cycle;
a display providing a graphical user interface that provides information relating to the project cycle, wherein the project cycle comprises a plurality of segments;
the plurality of segments having an identified order, wherein the starting time of a segment is dependent on an ending time of a previous segment occurring directly previous to the segment in the identified order;
a processor that identifies at least one uncompleted segment within the project cycle;
the graphical user interface including at least one icon for indicating an uncompleted segment within the project cycle;
a processor that identifies an ending time associated with a most recently completed segment;
the graphical user interface providing a function for associating the at least one uncompleted segment with the most recently completed segment; and
a processor that adjusts the starting time of the at least one uncompleted segment based upon the ending time of the most recently completed segment;
the graphical user interface displaying the adjusted starting time of the at least one uncompleted segment.

16. The system of claim 15, wherein the project cycle is associated with a project cycle time designating a length of time for completion of the project cycle; and
further comprising adjusting the project cycle time based upon the adjustment of the at least one uncompleted segment starting time;
the graphical user interface displaying the adjusted project cycle time.

17. The system of claim 15, further comprising identifying a goal cycle time associated with each segment within the project cycle, wherein the goal cycle time designates a length of time for completion of a segment.

18. The system of claim 17, wherein the graphical user interface displays the uncompleted segments having an actual cycle time greater than the goal cycle time.

19. The system of claim 17, further comprising identifying a percentage of segments completed within the goal cycle time; and
wherein the graphical user interface displays the percentage of segments completed within the goal cycle time.

20. The system of claim 19, wherein the graphical user interface provides a function to a user for placement of a visual indicator.
